(19) United States
(12) Patent Application Publication
(10) Pub. No.: US 2007/0192158 A1
(43) Pub. Date: Aug. 16, 2007

(54) Performing scheduled device management

(75) Inventor: Te-Hyun Kim, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/655,851

(22) Filed: Jan. 22, 2007

Related U.S. Application Data
(60) Provisional application No. 60/760,942, filed on Jan. 23, 2006.
(60) Provisional application No. 60/760,943, filed on Jan. 23, 2006.
(60) Provisional application No. 60/762,517, filed on Jan. 27, 2006.

(30) Foreign Application Priority Data
Dec. 8, 2006 (KR) 10-2006-0124992
Jan. 18, 2007 (KR) 10-2007-0005812

(51) Int. Cl. G06F 9/46

(52) U.S. Cl. 705/9

(57) ABSTRACT

For performing scheduled device management, a server generates a scheduling context that includes commands for device management and generates a device management object that includes a schedule for executing such commands, and transmits these to a terminal. The terminal monitors the schedule included in the management object, and according to the schedule, executed the commands within the scheduling context.

The present disclosure relates to performing scheduled device management.

In general, device management (DM) technology relates to showing (or indicating), to a device management (DM) server (or other network entity), the resources of a device management (DM) client (i.e., a terminal or other user device) as management objects that exist on a device management (DM) tree (or other type of hierarchy structure or logical format that is used for device management), allowing access thereto, and letting the DM server easily manage the terminal.

In such DM technology, the DM server may instruct the terminal to process commands for device management, while the terminal being managed, after immediately performing the corresponding command, may report the results thereof to the DM server. Also, the DM server may request the terminal to change, update, delete or otherwise process a particular function for device management.

One aspect of this disclosure is the recognition by the present inventors of the following drawbacks in certain DM techniques. Namely, in some DM techniques, the terminal may request the DM server for DM commands only when there is an error or malfunction within the terminal. As such, the diagnostic procedures of the terminal become more expensive, and do not allow effective resolution of diagnostic problems because such problems cannot be anticipated or discovered before they occur.

Thus, in order to address the above drawbacks, this disclosure provides a terminal capable of receiving from a server a command for device management and a condition for executing the command before a potential problem will be issued, monitoring whether the condition is satisfied and then executing a command for device management if the condition is satisfied.

The accompanying Figures show various features of an exemplary embodiment(s) according to the invention, wherein:

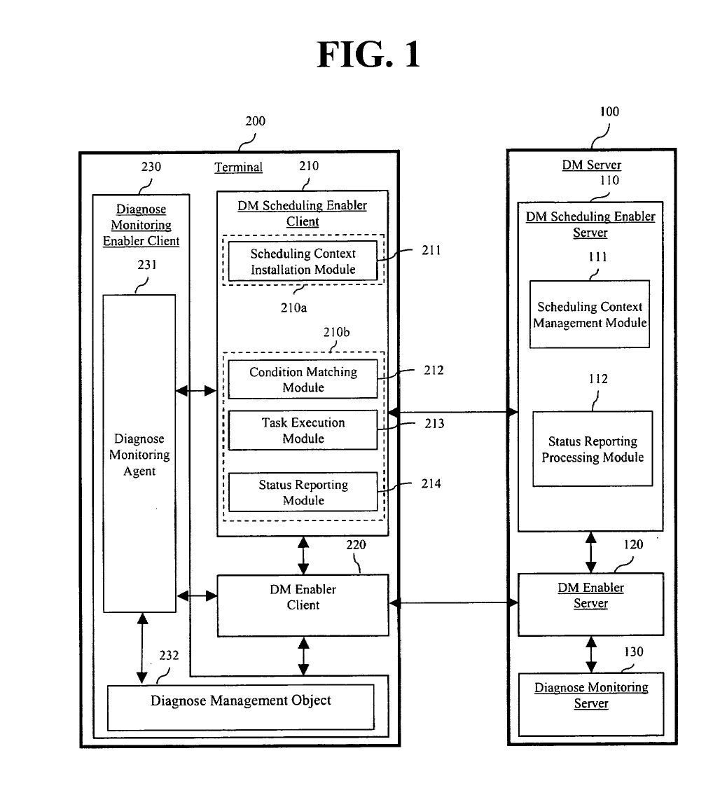

FIG. 1 shows a device management (DM) terminal and a device management (DM) server;

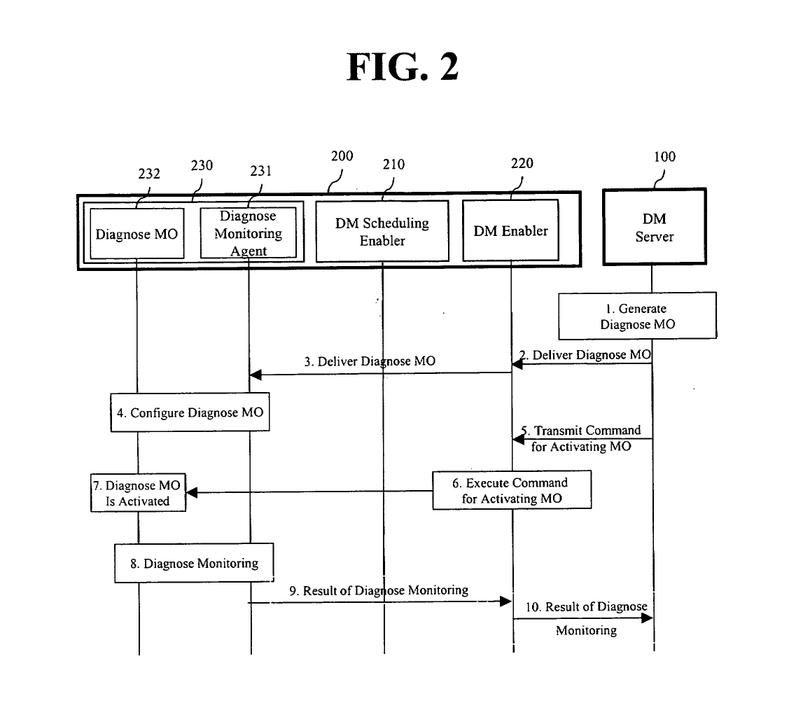

FIG. 2 is a flow chart of one example of a method for diagnosing a terminal.

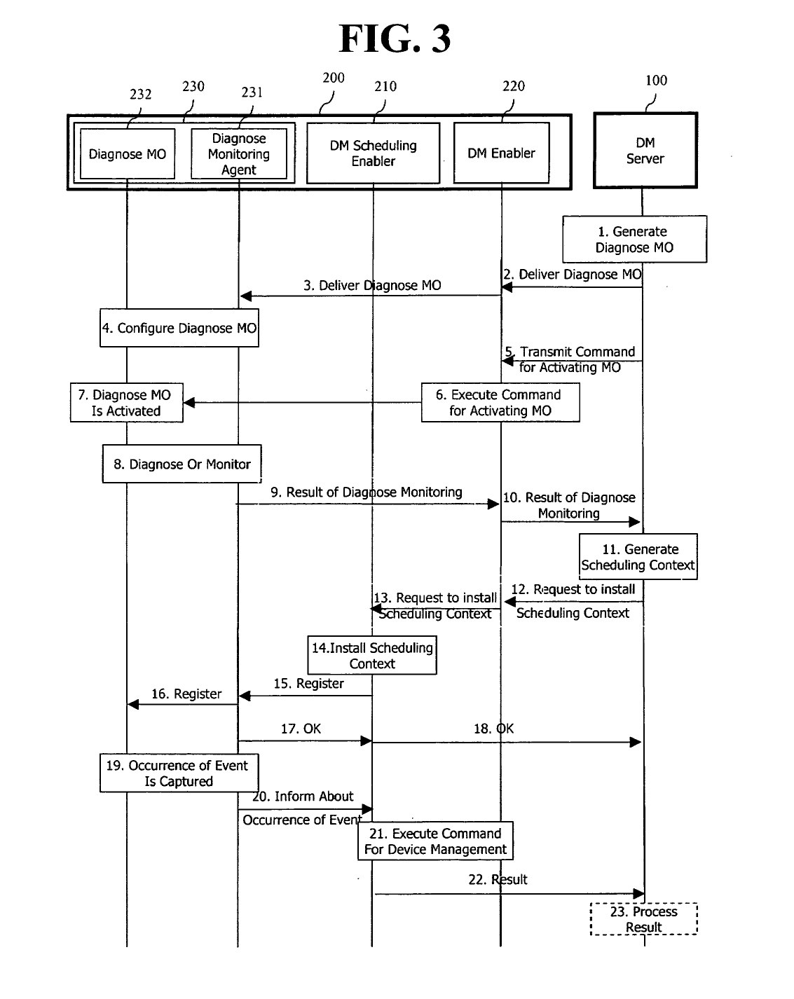

FIG. 3 is a flow chart of one example of a method for performing scheduled device management.

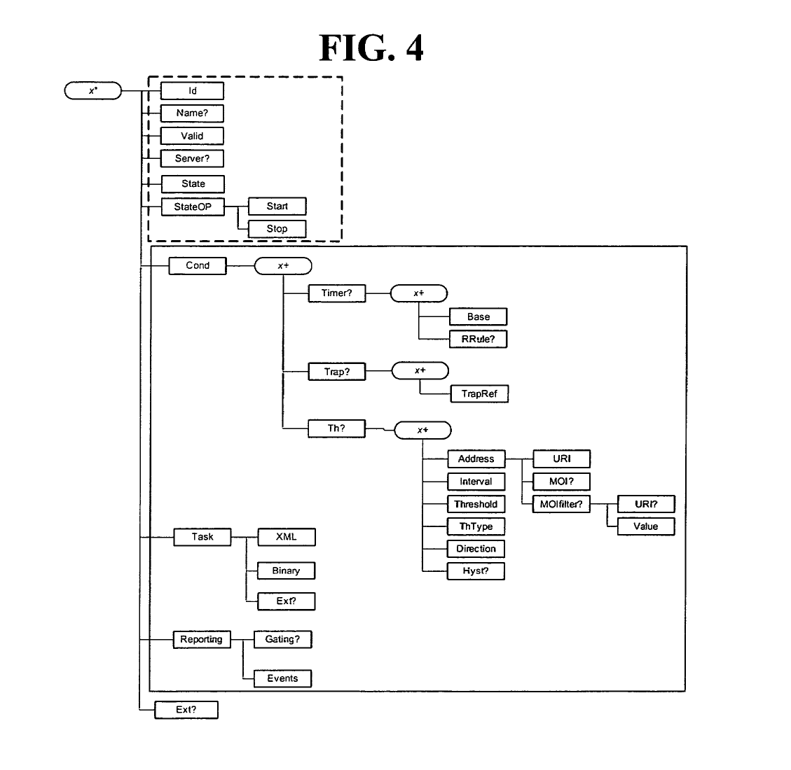

FIG. 4 is a view showing a scheduling context according to a first embodiment of the present invention as one exemplary tree structure

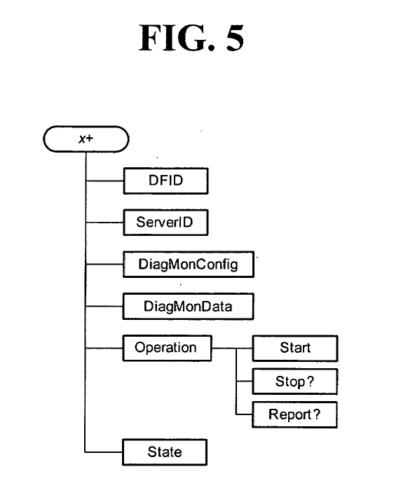

FIG. 5 is a view showing a diagnose management object according to a first embodiment of the present invention as one exemplary tree structure.

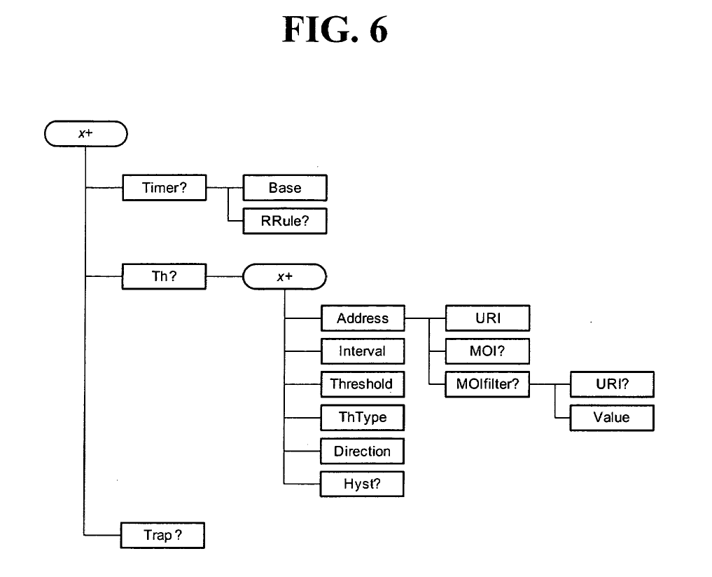

FIG. 6 is a view showing a schedule management object according to a second embodiment of the present invention as one exemplary tree structure.

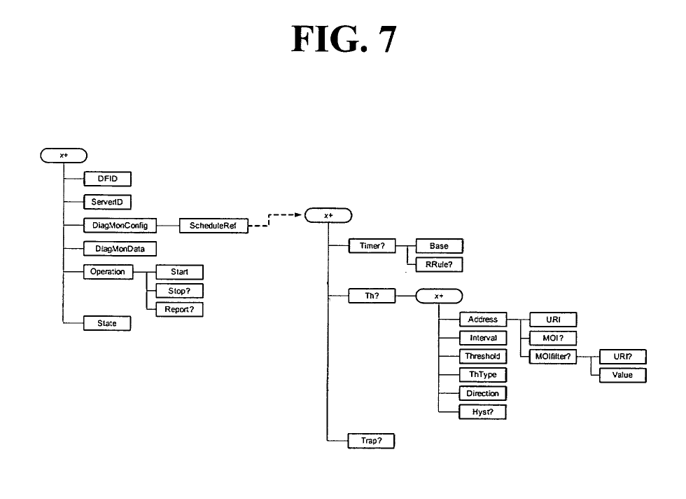

FIG. 7 is a view showing a diagnose management object connected to the schedule management object, shown in the FIG. 6, as one exemplary tree structure.

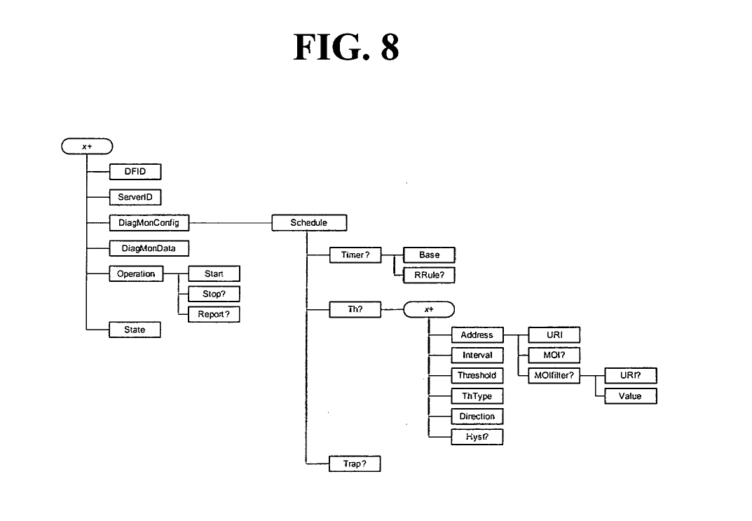

FIG. 8 is a view showing a diagnose management object according to a third embodiment of the present invention as one exemplary tree structure.

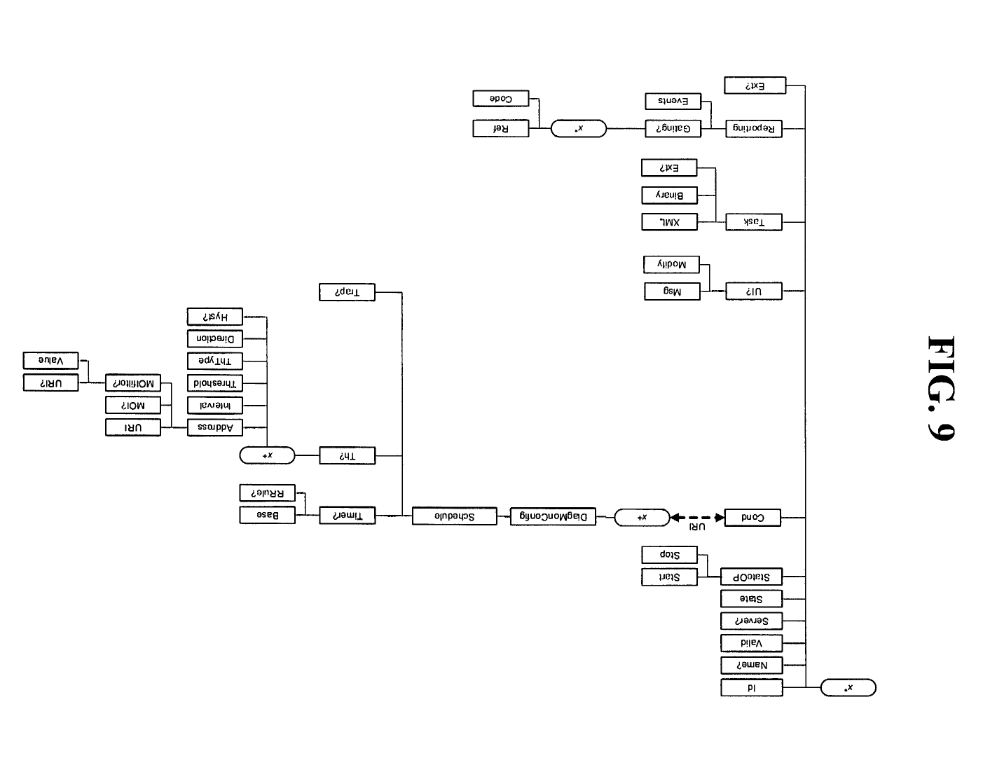

FIG. 9 is a view showing a scheduling context connected to the diagnose management object, shown in the FIG. 8, as one exemplary tree structure.

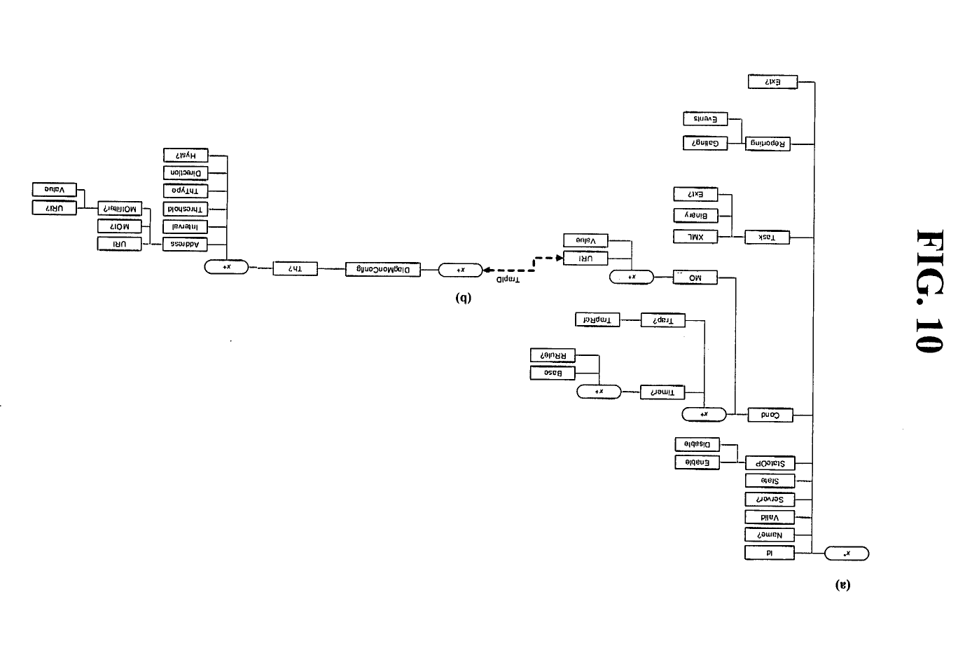

FIG. 10 is a view showing a scheduling context and a diagnose management object according to a fourth embodiment of the present invention as one exemplary tree structure.

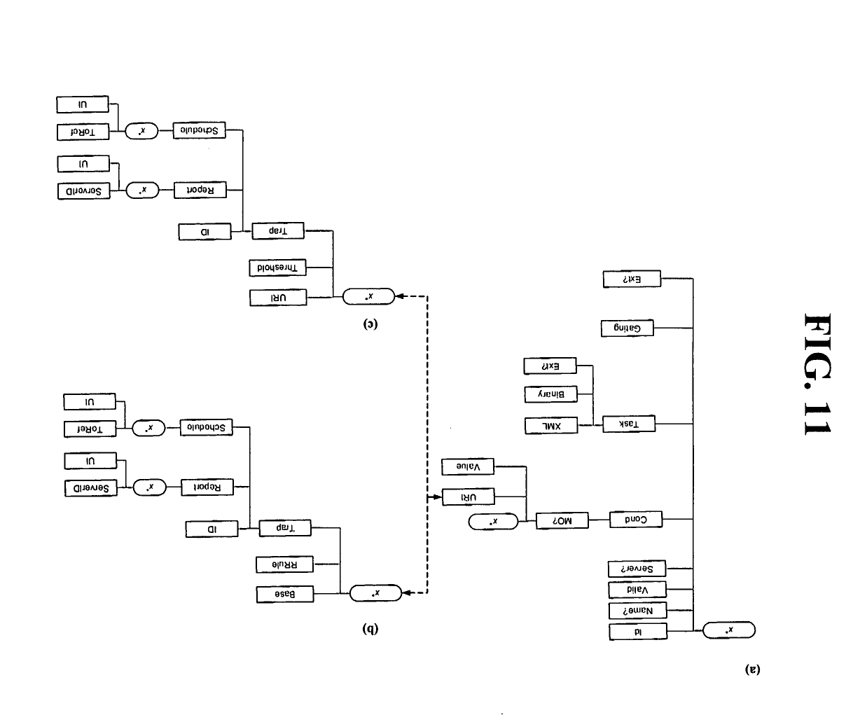

FIG. 11 is a view showing a scheduling context and a schedule management object according to a fifth embodiment of the present invention as one exemplary tree structure.

As shown in FIG. 1, a DM system according to an exemplary embodiment(s) invention may include a DM server 100 and a terminal 200. It can be understood that other types of servers, network entities, or the like may be implemented. The terminal may be a user device, user equipment (UE), a mobile terminal, a client device, or the like.

The DM server 100 may comprise a DM scheduling enabler server 110 (comprising hardware, software, or any combination thereof) and DM enabler server 120 (comprising hardware, software, or any combination thereof). It can be understood that additional and/or alternative entities and elements may exist within the DM server 100.

The DM scheduling enabler server 110 may comprise a scheduling context management module 111 (comprising hardware, software, or any combination thereof) and a status reporting processing module 112 (comprising hardware, software, or any combination thereof). It can be understood that additional and/or alternative entities and elements may exist within the DM scheduling enabler server 110.

The scheduling context management module 111 can generate a scheduling context (i.e., an outline, basis, framework, etc. used in performing device management scheduling) and request the terminal 200 to install the same. The scheduling context management module 111 can establish a DM session with the terminal 200 and request the terminal 200 to install the generated scheduling context through the established DM session.

The scheduling context may include at least one of task element (e.g., a first element) which specifies a message including at least one command (or instructions) for device management, and a condition element (e.g., a second element) which specifies a condition (a factor, circumstance, etc.). The condition may be at least one of a timer-based condition, a trap-based condition, and a threshold-based condition. Here, the term “trap” (as used in a trap item, a trap mechanism, etc.) can be understood by those skilled in the art as referring to a certain type of condition-based scheme i.e., an occurrence of a particular event causes hardware, software (i.e., operating system), or their combination to operate a in certain way. Furthermore, the scheduling context may further comprise additional information as illustrated in FIG. 4, which will be explained is more detail later.

The status reporting processing module 120 may receive from the terminal 200 a state report, for example, a result from executing the command, or a result from diagnosing and monitoring the terminal 200 and processes the same.

The DM enabler server 120 may set a session with the terminal 200 and then request the terminal 200 to perform device management, but not through scheduling context. In detail, the DM enabler server 120 may generate a management object and then transmit the management object, or request the terminal 100 to generate a management object. Then, the DM enabler server 120 may access to the terminal 200 through the management object, and manage the terminal 200.

The diagnose monitoring enabler server 120 may generate an appropriate diagnostic and monitoring package, and transmit the package to the terminal 200. The package may be, for example, a diagnose monitoring management object as shown is FIG. 5. Also, the diagnose monitoring enabler server 120 may receive at least one of a result of the diagnosing and monitoring and an event occurred in the terminal 200.

Terminal 200

As shown, the terminal 200 may include a DM scheduling enabler client 210, a DM enabler client 220, and a diagnose monitoring enabler client 230. It can be understood that additional and/or alternative entities and elements may exist within the terminal 200.

The DM scheduling enabler client 210 may include a first entity 210a which install, upon receipt from the server 100, the scheduling context, and a second entity 210b which executes the command for device management. It can be understood that additional and/or alternative entities and elements may exist within the DM scheduling enabler client 210.

The first entity 210a may include a scheduling context installation module 211. The scheduling context installation module 211 processes the scheduling context installation request from DM server 100. Namely, the scheduling context installation module 211 may install the scheduling context in the form of a DM tree (or other type of hierarchy structure or logical format that is used for device management).

Herein, the scheduling context installation module 211 may perform a supplementary procedure in order to process the scheduling context installation request. For example, the scheduling context installation module 211 requests the diagnose monitoring enabler client 230 to notify when a particular event occurs.

The scheduling context installation module 211 can selectively verify the validity of the scheduling context before installation thereof.

The second entity 210b may include a condition matching module 212, a task execution module 213, and a status reporting module 214. It can be understood that additional and/or alternative entities and elements may exist within the second entity 210b.

The condition matching module 212 can monitor whether the condition is matched, and if so, the condition matching module 212 can request the task execution module 213 to perform the command corresponding to the condition. If the condition corresponds to a trap-based condition, the condition matching module 212 determines that the condition is matched, if an occurrence of a particular event is notified by the diagnose monitoring enabler client 230.

The task execution module 213 may cooperate with the DM enabler client module 220 so that the command can be executed, when the condition to execute the command is determined to be matched.

The status reporting module 214 may report one or more of states (or status) of the scheduling context in the terminal 200 and the result(s) from executing the command to the DM server 100. The status reporting module 215 creates a report message (or some other type of report indication) by using one or more of the results and the status of the scheduling context, and then transmits the report message to the DM server 100.

The DM enabler client module 220 may execute the command for device management by cooperating with the command execution module 213. In detail, the DM enabler client module 220 may receive the command from the command execution module 213, executes the command, and then returns a result from executing the command to the command execution module 213.

Also, the DM enabler client module 220 sets a session with the DM server 100 in order for the DM scheduling enabler client 110 to communicate with the DM server 100. Furthermore, the DM enabler client 220 receives a diagnose management object 232 and delivers it to the diagnose monitoring enabler client 230.

Meanwhile, the diagnose monitoring enabler client 230 comprises a diagnose monitoring agent 231, and the diagnose management object 232.

The diagnose monitoring agent 231 may diagnose and monitor the terminal 200 according to the management object diagnose monitoring 232. And, the diagnose monitoring agent 231 may transmit a result for diagnosing and monitoring the terminal 200 to the DM server 100

The diagnose management object 232 includes information required for the diagnose monitoring agent 231 to diagnose or monitor the terminal 200. In other word, the diagnose management object 232 may control an operation of the diagnose monitoring agent 231. Herein, the diagnose management object 232 may be the same as shown in FIG. 5.

As stated above, the DM server 100 may include the DM scheduling enabler 110 and the DM enabler 120, and the terminal 200 may include the DM scheduling enabler client 210, the DM enabler client 220, the diagnose monitoring enabler client 230. However, the server 100 or the terminal 200 may be constructed by combining a processor (not shown), a network interface (not shown), and a storage means (not shown) with one another. Here, it can be understood that other similar hardware, software, or any combination thereof may also be used.

Operation

The operation of the terminal and DM server according to the exemplary embodiment(s) will now be described in detail with reference to FIGS. 2 to 3. Although FIG. 2 to FIG. 3 do not. show all elements in detail, it should be considered that each operation is performed by various corresponding elements of the DM server 100 and the terminal 200.

FIG. 2 is a flow chart of one example of a method for diagnosing a terminal.

As shown, the DM server 100 provides a command for device management to be executed in the terminal 200 and a condition to execute the command to the terminal 200. Then, the terminal 200 executes the command if it is determined that the condition is matched. Accordingly, the terminal 200 recognizes that the DM server 100 immediately provides the command for device management, whenever the terminal 200 requires the command.

1) The DM server 100, more specifically, the diagnose monitoring enabler server 130 creates the diagnose management object.

2) The DM server 100 sets (establishes) a DM session with the terminal 200, and transmits the created diagnose management object to the terminal 200.

3) Then, the terminal 200, more specifically, the DM enabler client 220 receives the diagnose management object and delivers the diagnose management object to the diagnose monitoring agent 231.

4) The diagnose monitoring agent 231 configures the diagnose management object within the terminal 200.

5) Thereafter, the DM server 100 transmits a command for activating the diagnose management object to the terminal 200.

6) Then, the terminal 200, more specifically, the DM enabler client 220 receives the command. And, the DM enabler client 220 executes the command.

7) The diagnose management object is activated in responses to executing the command.

8) The diagnose monitoring agent 231 start diagnosing or monitoring the terminal 200. Here, one or more of information related to a hardware(s), a memory dump, a error, a code causing the error, application are collected.

9) The diagnose monitoring agent 231 delivers a result for diagnosing or monitoring the terminal 200 to the DM enabler client 220.

10) Then, the DM enabler client 220 transmits the result to the DM server 100.

FIG. 3 is a flow chart of one example of a method for performing scheduled device management.

As shown in FIG. 3, the DM server 100 creates a scheduling context based on the result from diagnosing or monitoring the terminal 200 and transmits a request of installation of the scheduling context.

Each procedure of such process is as follows.

1)˜10) Procedures are similar to procedures as shown in the FIG. 2, so that descriptions of the same procedures are omitted so as not to unnecessarily obscure the invention.

11) The DM server 100 (specifically, the scheduling context management module 111) creates a scheduling context based on the result from diagnosing or monitoring the terminal 200. That is, the DM server 100 (specifically, the scheduling context management module 111) creates the scheduling context in order to find a problem to be issued in near future according to the result from the diagnosing or monitoring the terminal 200, and to solve such problem

12) The DM server 100 requests the terminal 200 to install the generated DM scheduling context by using a DM protocol.

13) Then, the DM enabler 220 of the terminal 200 delivers the scheduling context to the DM scheduling enabler client 210.

14) The DM scheduling enabler client 210 (specifically, the scheduling context installation module 211) processes the installation request.

15) Subsequently, the DM scheduling enabler client 210 (specifically, the scheduling context installation module 211) requests the diagnose monitoring agent 231 to notify when the particular event occurs. In this case, the request can be transferred through a register message.

16) In response to the request, the diagnose monitoring agent 231 register to the diagnose management object 232.

17) The diagnose monitoring agent 231 notifies the completion of the register to the DM scheduling enabler client 210. The notification can be achieved by transferring an ACK message to the DM scheduling enabler client 210.

18) Upon receiving the ACK message, the DM scheduling enabler client 210 notifies the completion of the installation of the scheduling context to the DM server 100. The notification can be achieved by transferring the ACK message to the DM server 100.

19˜20) Thereafter, if an occurrence of a particular event is captured, the diagnose monitoring agent 231 inform the DM scheduling enabler 210 about the occurrence.

21) Then, the DM scheduling enabler 210 (specifically, the condition matching module 212) determines whether the occurred particular event can make the condition satiable. If the condition is satisfied, the condition matching module 212 request the task execution module 213 to execute a command for device management in the scheduling context.

22) If the execution is completed, the status reporting module 214 of the DM scheduling enabler client 210 report a result from executing the command to the DM server 100.

23) Then, the DM server 100 (specifically, the status reporting processing module 112 of the DM scheduling enabler server 110) receives the report and, parse the report.

The exemplary methods have been described. It can be understood that the methods can be implemented by software, hardware or a combination thereof. For example, the methods can be stored in a storage medium (i.e., an internal memory of a mobile terminal, a Flash memory, a hard disk, etc.,) or can be implemented as codes or command language in a software program that can be executed by a processor (e.g., an internal microprocessor of the mobile terminal).

Scheduling Context

FIG. 4 is a view showing the scheduling context as one exemplary tree structure (with nodes or other types of points, placeholders, etc. in a hierarchy structure).

As shown in FIG. 4, the scheduling context may include a general information part and a schedule part.

The general information part may include an ID node for representing an identifier of the scheduling context, a name node for representing a name of the scheduling context, a valid node for specifying a valid period of the scheduling context, a server node for representing an owner of the scheduling context, a state node for representing a state of the scheduling context, and a sate operation node (or, StateOP node) for controlling the state of the scheduling context. Clearly, other types of additional or alternative nodes are possible.

The schedule part may include one or more of a task node (i.e., a first node) for specifying a message including at least one command for device management, a condition node (i.e., a second node) for specifying a condition to execute the command, and a reporting node (i.e., a third node) for specifying whether or not a result from executing the command and a status of the scheduling context should be reported to the server.

The condition node may include at least one of a timer node for specifying a timer-based condition, a trap node for specifying a trap-based condition i.e. whether a particular event occurs or not, and a threshold node for specifying a threshold-based condition, i.e. whether a value of a particular management object in the terminal has reached a threshold value.

First, the timer node may specify one of a given point in time, a duration, a period, and an interval. Such timer node may include a base node for specifying point in time expressed in complete representation, and a recurrence rule (RRule) node for specifying whether the condition is recursive or not. Therefore, if a recurrence is not specified in recurrence rule node, the timer-based condition may be disabled after the command is executed once.

And, the trap node may include a trap reference node (or TrapRef node, or identifier) for specifying an identifier of a particular event.

The threshold node, as illustrated in FIG. 2, includes at least one of a Address node to specify an address of the management object, a Interval node to specify an interval for monitoring the value for the management object, a Threshold node to specify the threshold, a ThFormat node to specify which a format of the threshold is of bool, character, integer, float, date, or time, a ThType node to specify whether a type of the threshold is absolute value or delta value, a Direction node to specify which the threshold is of rising, falling and static, and a Hysteresis node to specify a margin for the threshold.

Also, the Address node includes at least one of a URI node to specify an uniform resource identifier (URI) of the management object, a MOI node to specify a the management object identifier (MOI), and a MOIfilter node to specify an additional information for distinguishing the specified management object from other management objects due to a coexistence of management objects with same MOI if the MOI node is used.

The URI node may specify a full address, if the MOI node is not present. However, if the MOI node is present, then the URI node may specify a relative address to the root of the management object.

In particular, the MOIfilter node includes at least one of a URI node, a Value node, and a Format node.

The URI node included in the MOIfilter node specifies a uniform resource identifier (URI) of the specified management object, relative to the root of the management object.

The Value node included in the MOIfilter node specifies a value to be compared with a value of the specified management object indicated by the URI node of the MOIfilter node, in order to distinguish the specified management object from other management objects in case there are more than one management object with the same management object identifier (MOI). The value in the Value node can be compared with the value of the URI, if the URI node included in the MOIfilter node is present. However, if the URI node included in the MOIfilter node is not present, then the value in Value node can be compared with the root name of the management object.

The Format node included in the MOIfilter node specifies a format of the value in the Value node. The possible values are b64, bin, bool, int, xml, date, time, or float. If the Format node is not present, then the format of the Value node would be considered as character.

Meanwhile, the Threshold node specifies the threshold, and a value of the Threshold node is the numeric text string representing the various formats of the threshold value. The actual format of the threshold is determined by the ThFormat node. The sample statistics of the selected management object will be compared with the value of the Threshold node. But, if the currently sampled value is the first one (e.g. after power recycles, the scheduling operation is just started), and if there is no previous sample, the last sample is not taken into account.

The ThFormat node specifies the real format of the threshold and the hysteresis. Possible values of the ThFormat node are, bool, chr, int, date, time, or float.

The ThType node specifies the threshold type. Possible values of the ThType node are Absolute or Delta. If the value is Absolute, the sampled value of the management object will be compared directly with the threshold. If the value is Delta, the sampled value at the last sampling will be subtracted from the currently sampled value, and the difference will be compared with the threshold.

The Direction node specifies the behavior of the value changes as the threshold crossing event occurs. Possible values are rising, falling or static. The static-threshold means that the condition match occurs when the sampled value is equal to the threshold irrespective of the direction of the crossing. When this threshold is the rising-threshold, a single condition match occurs if the currently sampled value is greater than or equal to this threshold, and if the last sample was less than this threshold. When this threshold is the falling-threshold, condition match occurs in the opposite direction. When this threshold is set to the static-threshold, a single condition match event occurs when the current sample value is equal to this threshold irrespective of the crossing, and if the last sample was not equal to this threshold. But the logical status of the condition will be true as long as the sampled value is equal to this threshold.

The Hysteresis node specifies a value of the hysteresis. The value of the Hysteresis node is the text string representing the various formats of the hysteresis value. The real format of the hysteresis value is determined by the ThFormat node. If the hysteresis is specified, after a threshold crossing event is generated, another one will not be generated until the sampled value falls below or rises above this threshold by the margin specified by the hysteresis. Using hysteresis prevents too many threshold crossing events from being generated if the sample valued fluctuates around the threshold due to noise. For example, in case of rising-threshold, once the command is executed, it will not be executed again, unless the sampled value becomes less than the threshold by the margin specified by this node.

Meanwhile, the task node can include a XML node specifying whether the message including a command with XML-based (Extensible Markup Language) data, and a Binary node specifying whether the message including the command binary-based data.

The reporting node includes at least one of a gating node specifying whether the result from executing the command should be reported to the DM server 100 or not, and a event node specifying whether the state of the scheduling context should be reported to the DM server 100.

FIG. 5 is a view showing a diagnose management object according to a first embodiment of the present invention as one exemplary tree structure (with nodes or other types of points, placeholders, etc. in a hierarchy structure).

Referring to FIG. 5, the diagnose management object is illustrated as one exemplary tree structure.

The diagnose management object includes information required to diagnose or monitor the terminal 200 as explained above. In other word, the diagnose management object includes a DFID node, a Server ID node, a Diagnose Monitoring Config node, a Diagnose Monitoring Data node, a Operation node, and a State node.

The DFID node specifies a name of a diagnose function. And, the Server ID node specifies an identifier of the DM server 200 to be reported about

The DFID node indicates a name of a diagnosis function. The Server ID node reports the state of diagnosis operation performance while the diagnosis function is being performed or instructs (indicates) the identification (ID) of the device management server to which the results after execution are to be reported. The Diagnose Monitoring Config node refers to a Folder node or an Interior node that stores setting values needed for a particular diagnosis function. The Diagnose Monitoring Data node refers to a node or folder node for storing the results of diagnosis.

The Start node within the Operation node is a node for allowing the DM Server (100) to perform the diagnosis function in a remote manner. Also, the Stop node within the Operation node is a node for allowing the DM Server (100) to stop the diagnosis function that is being performed. The Report node within the Operation node is anode for allowing the DM Server (100) to perform reception of a report of the diagnosis results. The State node is a node for informing about a state of the diagnosis function.

FIG. 6 is a view showing a schedule management object according to a second embodiment of the present invention as one exemplary tree structure. And, FIG. 7 is a view showing a diagnose management object connected to the schedule management object, shown in the FIG. 6, as one exemplary tree structure.

According to a second exemplary embodiment, the diagnose monitoring enabler (230) may monitor whether or not the condition(s) are matched.

To do so, as may be understood by referring to FIGS. 6 and 7, the conditions (namely, the Timer node, the Trap node, the Threshold node) may be separated from the scheduling context to thus be comprised of a separate (independent) Management Object.

Also, to do so, the Diagnose Monitoring Config node of the diagnose management object may include a Schedule Reference node that specifies (indicates) an address (or ID or URI) of the schedule management object. Accordingly, the schedule management object may be connected to the diagnose management object, and the diagnose monitoring enabler (230) may monitor whether or not the conditions are matched. If it is determined that the conditions are matched, the diagnose monitoring enabler (230) generates an event, which is delivered (transferred) to the condition matching nodule (212). Here, the condition matching module (212) determines that the condition is matched according to the event, and requests the task execution module (213) to execute the command.

FIG. 8 is a view showing a diagnose management object according to a third embodiment of the present invention as one exemplary tree structure. FIG. 9 is a view showing a scheduling context connected to the diagnose management object, shown in the FIG. 8, as one exemplary tree structure.

According to a third embodiment, similar to the second embodiment, the diagnose monitoring enabler (230) may monitor whether or not the conditions are matched.

To do so, as shown in FIG. 8, the conditions (namely, a Timer node, a Trap node, a Threshold node) are separated in the scheduling context and may be included in the diagnose management object. Also, as shown in FIG. 9, the diagnose management object and the Condition node of the scheduling context may be connected via an address or ID (or URI).

Accordingly, if the diagnose monitoring enabler (230) determines that the conditions are matched, an event is generated and delivered (transferred) to the condition matching module (212). Here, the condition matching module (212) determines that the conditions have matched according to the event, and can request the task execution module (213) to execute the command.

FIG. 10 is a view showing a scheduling context and a diagnose management object according to a fourth embodiment of the present invention as one exemplary tree structure.

As may be understood by referring to FIG. 10, according to the fourth embodiment, the diagnose monitoring enabler (230) can monitor whether or not the threshold-based conditions (namely, the conditions stored in the Threshold node) are matched, and the condition matching module (212) can monitor whether of not the timer-based conditions (namely, the conditions stored in the Timer node) and the event-based conditions (namely, the conditions stored in the Trap node) are matched.

As illustrated in FIG. 10(a), the condition node of the scheduling context may include a timer node, and a trap node. And the condition node may further include a management node (or, MO node) which indicates a particular management object in the terminal 200. The management object node may include at least one of a URI node which indicates an uniform resource identifier of the particular management object, and a value node which specifies a value for additionally identifying whether the particular management object indicated by the URI node is intended. However, it is clear that other implementations of these is nodes (or additional and/or alternative nodes) are also possible.

As illustrated in FIG. 10(b), the separated management object may include a diagnose monitoring configuration node (or, DiagMonConfig node). The diagnose monitoring configuration node may include the threshold node as explained above.

Hereinafter, the scheduling context and the separated management object as explained above will be further explained by some examples. If a value of any management object crosses the threshold indicated by the threshold node of the diagnose monitoring configuration node, an event occurs. Then, it is checked whether the any management object which has occurred the event corresponds to the particular management object indicated the URI node of the management object node in the scheduling context. If the any management object corresponds to it, it is further checked whether the occurred event corresponds to an event indicated by the trap node of the scheduling context. If the occurred event corresponds to it, the condition matching module 212 determines that the condition is satisfied, and then the task execution module 213 executes the command.

FIG. 11 is a view showing a scheduling context and a schedule management object according to a fifth embodiment of the present invention as one exemplary tree structure.

According to a fifth embodiment, the terminal (200) can employ a different module to monitor the threshold-based conditions (namely, the conditions stored in the Threshold node), and if a condition match is determined, an event is generated. Also, according to the fifth embodiment, the terminal (200) can employ another different module to monitor the timer-based conditions (namely, conditions stored in the Timer node), and if a condition match is determined, an event may be generated. If so, the condition matching module (212) receives the generated event, and can request the task execution module (213) to execute the command.

As illustrated in FIG. 11 (a), a condition node of a scheduling context includes only a management object. The management object node may include at least one of a URI node which indicates an uniform resource identifier of the particular management object, and a value node which specifies a value for additionally identifying whether the particular management object indicated by the URI node is intended.

As illustrated in FIG. 11 (b), a timer schedule management object including the timer node (which is apart from the scheduling context) may include at least one of a base node specifying a particular point in time to execute a command for device management, a recursive rule node (or, RRule node) specifying whether the particular point should recursively be used, and a trap node. The trap node may include at least one on an identifier node (or, ID node) specifying an identifier of a particular event which will occur if it arrives at the particular point, a report node, and a schedule node. Herein, the report node includes at least one of server identifier node (or, ServerID node) specifying an identifier of a server to which the particular event will be reported if the particular event occurs, and a user interaction node specifying whether to interact with user with respect to the occurrence of the particular event. The schedule node includes at least one of an user interaction node specifying whether to interact with user, and a reference node (or, ToRef node, or identifier) specifying an identifier of the scheduling context.

As illustrated in FIG. 11 (c), a threshold monitoring management object including a threshold node (which is apart from the scheduling context) may include at least one of a uniform resource identifier node (or, URI node) specifying an identifier of a particular management object to be monitored, and a threshold node specifying a threshold of the particular management object to be monitored, and a trap node.

Hereinafter, the scheduling context and the time schedule management object as explained above will be further explained by some examples. If it is found that the point in time indicated in the base node has arrived, an event occurs. Then, it is checked whether an identifier of the occurred event corresponds to the identifier specified in the identifier node of the trap node. If the identifier of the occurred event corresponds to it, the terminal 200 reports the server according to the server identifier node of the report node. And, the occurred event is delivered to the scheduling context specified by the ToRef node. Then, the terminal 200 executes a command for device management specified in a task node of the scheduling context.

Also, the scheduling context and the threshold monitoring management object as explained above will be further explained by some examples. If a value of the particular management object specified by the URI node crosses the threshold specified by the threshold node, an event occurs. And, it is checked whether an identifier of the occurred event corresponds to the identifier specified by the ID node of the trap node. If the identifier of the occurred event corresponds to it, the terminal 200 reports the server according to the server identifier node of the report node. And, the occurred event is delivered to the scheduling context specified by the ToRef node. Then, the terminal 200 executes a command for device management specified in a task node of the scheduling context.

As so far described, the terminal, the server and the methods may have the following characteristics.

That is, the present specification allows the desired device management to be automatically performed in appropriate time, by allowing a terminal to receive from a server a command for device management and a condition for executing the command before a potential problem will be issued, and thus to execute the command for device management if the condition is satisfied.

The present specification provides a terminal comprising: a first entity adapted to identify a first management object through an address or an identifier of the first management object, and to monitor whether it is on a schedule included in the identified first management object; wherein the address or the identifier is specified in a second management object; and a second entity adapted to execute a command for device management included in a scheduling context, if it is determined by the first entity that it is on the schedule.

Also, the present specification provides a terminal comprising a first entity adapted to monitor whether it is on a schedule included in a diagnose management object; and a second entity adapted to execute a command for device management included in a scheduling context, if it is determined by the first entity that it is on the schedule.

Also, the present specification provides a terminal, comprising: a first entity adapted to monitor whether a threshold-based condition is satisfied or not, according to a first schedule management object including the threshold-based condition; a second entity adapted to monitor whether a timer-based condition is satisfied or not, according to a second schedule management object including the timer-based condition; and a third entity adapted to execute a command for device management included in a scheduling context if at least one of the threshold-based condition and the timer-based condition is satisfied.

It should be noted that the features and concepts described herein are related to various types of standards with respect to device management (DM) that are governed by certain corresponding standards organizations. As such, various corresponding standards and/or the concepts specified therein are also part of this disclosure.

For example, certain aspects described herein are related particular standards (such as, OMA, GSM, 3GPP, 3GPP2, IEEE, etc.). As such, at least some of the features described herein are applicable to such standards that have been developed or that are continuing to evolve.

Although this specification specifies various names of commands, nodes, sub-nodes, etc. related to device management (DM), it can be clearly understood that such names and labels are merely exemplary. The features of the present invention are not meant to be so limiting, as other equivalent names or labels may be used, as long as they refer to the same or equivalent functions and/or features.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A terminal comprising:
a first entity adapted to identify a first management object through an address or an identifier of the first management object, and to monitor whether it is on a schedule included in the identified first management object; wherein the address or the identifier is specified in a second management object; and
a second entity adapted to execute a command for device management included in a scheduling context, if it is determined by the first entity that it is on the schedule.

2. The terminal of claim 1, wherein
the schedule comprises at least one of a timer-based condition, a trap-based condition, and a threshold-based condition.

3. The terminal of claim 1, wherein
at least one of the first management object, the second management object, and the scheduling context is received from a server.

4. The terminal of claim 1, wherein
at least one of the first management object, the second management object, and the scheduling context is stored in a device management tree in the terminal.

5. The terminal of claim 1, wherein
the second management object includes a schedule reference node specifying the address or the identifier of the first management object.

6. The terminal of claim 1, wherein
the first management object corresponds to a schedule management object, and
the second management object corresponds to a diagnose management object.

7. A terminal comprising
a first entity adapted to monitor whether it is on a schedule included in a management object; and
a second entity adapted to execute a command for device management included in a scheduling context, if it is determined by the first entity that it is on the schedule.

8. The terminal of claim 7, wherein
at least one of the management object, and the scheduling context is received from a server.

9. The terminal of claim 7, wherein
the management object includes a diagnose monitoring configuration node that includes the schedule.

10. The terminal of claim 7, wherein
the management object and the scheduling context is connected to each other through an address.

11. The terminal of claim 7, wherein
the schedule includes at least one of a timer-based condition, a trap-based condition, and a threshold-based condition.

12. The terminal of claim 7, wherein
the schedule includes a threshold-based condition.

13. The terminal of claim 12, wherein
the scheduling context further includes at least one of a timer-based condition, and a trap-based condition.

14. The terminal of claim 13, wherein
the first entity generates an event if the threshold-based condition is satisfied, and
the second entity determines whether the generated event satisfies the trap-based condition, and if so, executes the command.

15. The terminal of claim 7, wherein
the scheduling context includes a node which specifies an address or identifier of the management object.

16. A terminal, comprising:
a first entity adapted to monitor whether a threshold-based condition is satisfied or not, according to a first schedule management object including the threshold-based condition;
a second entity adapted to monitor whether a timer-based condition is satisfied or not, according to a second schedule management object including the timer-based condition; and
a third entity adapted to execute a command for device management included in a scheduling context if at least one of the threshold-based condition and the timer-based condition is satisfied.

17. The terminal of claim 16, wherein
at least one of the first schedule management object and the second schedule management object further includes a trap-based condition.

18. The terminal of claim 16, wherein
the scheduling context further includes a node which specifies an address or identifier of the diagnose management object.

19. A terminal, comprising:
a transceiver for receiving from a server at least one of a scheduling context including at least one command for device management, a schedule management object including a schedule for executing the command, and a diagnose management object; and
a processor for installing at least one of the scheduling context, the schedule management object, and the diagnose management object in a device management tree.

20. The terminal of claim 19, wherein
the processor monitors the schedule of the schedule management object through an address of the schedule management object which is specified in the diagnose management object, and executes the command for device management.

21. A terminal, comprising:
a transceiver for receiving from a server at least one of a scheduling context which includes at least one command for device management, and a diagnose management object which includes a schedule for executing the command, and; and
a processor for installing at least one of the scheduling context, and the diagnose management object in a device management tree.

22. The terminal of claim 21, wherein
the processor monitors the schedule of the diagnose management object, and executes the command for device management.

23. The terminal of claim 21, wherein
the schedule includes at least one of a timer-based condition, a trap-based condition, and a threshold-based condition.

24. The terminal of claim 21, wherein
the schedule includes a threshold-based condition.

25. The terminal of claim 24, wherein
the schedule further includes at least one of a timer-based condition, and a trap-based condition.

26. A terminal, comprising:
a transceiver for receiving from a server at least one of a first schedule management object including a timer-based condition, a second schedule management object including a threshold-based condition, and a scheduling context including at least one command for device management; and
a processor for installing at least one of the first schedule management object, the second schedule management object, and the scheduling context in a device management tree.

27. A method for performing scheduled device management by a terminal, the method comprising:
monitoring whether it is on a schedule according to a diagnose management object; and
executing a command for device management included in a scheduling context if it is on the schedule as a result of the monitoring.
